(19) United States
(12) Patent Application Publication
(10) Pub. No.: US 2011/0314027 A1
(43) Pub. Date: Dec. 22, 2011

(54) INDEX BUILDING, QUERYING METHOD, DEVICE, AND SYSTEM FOR DISTRIBUTED COLUMNAR DATABASE

(75) Inventors: Meng Xu, Beijing (CN); Ling Qian, Beijing (CN); Zhiguo Luo, Beijing (CN); Leitao Guo, Beijing (CN); Peng Zhao, Beijing (CN)

(73) Assignee: CHINA MOBILE COMMUNICATIONS CORPORATION, Beijing (CN)

(21) Appl. No.: 13/127,031

(22) PCT Filed: Nov. 3, 2009
(86) PCT No.: PCT/CN09/01221

§ 371 Date: Jul. 19, 2011

(30) Foreign Application Priority Data
Nov. 3, 2008 (CN) 200810225486.3

(51) Int. Cl. G06F 17/30

(52) U.S. Cl. 707/743; 707/770; 707/E17.014; 707/E17.002

(57) ABSTRACT

An index building, querying method, device and system for distributed columnar database are provided. The index building method for distributed columnar database includes: obtaining a column field from a distributed columnar database, generating a column index file in which the column field is a key word, the column index file comprising the mapping relationship between the value of the column field in the distributed columnar database and the corresponding Row field value; storing the column index file to a index catalogue corresponding to the column field in the distributed columnar database.

### FIELD OF THE INVENTION

The present invention relates to a distributed columnar database and particularly to a method for creating an index of a distributed columnar database and method for querying a distributed columnar database and a device and system thereof.

### BACKGROUND OF THE INVENTION

A distributed columnar database provides a good distributed solution to a rapid data query and can improve effectively the rate of a data query while being capable of storage mass data.

The distributed columnar database is featured by a required field of Row as a keyword which can not be duplicated and is arranged in sequence in a data table. If a number N of column fields are included in a original data table, then the whole table is stored as a number (N−1) of sub-tables in the distributed columnar database, that is, each of column fields other than the field of Row corresponds to one of the sub-tables.

An example is presented as follow:

Data Table 1: GNTABLE

| Row | Time | UserID | SourceIP | ObjectIP | SingalType |
|---|---|---|---|---|---|
| 1 | 20080909- | 13910001000 | 10.1.6.124 | 10.1.7.22 | createPDP |
| | 12:00:00 | | | | |
| 2 | 20080909- | 13810001000 | 10.1.6.125 | 10.1.6.124 | delPDP |
| | 12:00:00 | | | | |
| 3 | 20080909- | 13910001000 | 10.1.7.22 | 10.1.6.124 | responsePDP |
| | 12:00:01 | | | | |
| 4 | 20080909- | 13910001000 | 10.1.7.22 | 10.1.6.124 | createPDP |
| | 12:00:01 | | | | |

Table 1 above is an original data table GNTABLE in a distributed columnar database, which includes the field of Row arranged in sequence and other column fields of Time, User ID (UserID), Source IP address (SourceIP), Object IP address (ObjectIP) and Signal Type (SingalType).

In the columnar database, corresponding sub-tables are stored respectively for the column fields (Time, UserID, SourceIP, ObjectIP and SingalType). Taking the column fields of Time and UserID as an example, the stored corresponding sub-tables are as depicted in the following Tables 2 and 3 respectively:

TABLE 2

| Row | Time |
|---|---|
| 1 Time | 20080909-12:00:00 |
| 2 Time | 20080909-12:00:00 |
| 3 Time | 20080909-12:00:01 |
| 4 Time | 20080909-12:00:01 |

TABLE 3

| Row | UserID |
|---|---|
| 1 UserID | 13910001000 |
| 2 UserID | 13810001000 |
| 3 UserID | 13910001000 |
| 4 UserID | 13910001000 |

A distributed columnar database system includes a master server (Master) and tablet servers (TabletServer). Particularly, a mapping relationship between values of the field of Row and the tablet servers is stored in the master server, and tablet data of the distributed columnar database is stored respectively in the tablet servers. The so-called tablet data refers to several tablets into which an original data table is divided by row. A tablet includes several rows with all of data in the several rows. Each piece of tablet data may be stored in a respective tablet server (of course, plural pieces of tablet data may be stored in one tablet server), and the respective tablet data is ranked by Row. A value of Row in the first row of each tablet data is represented as a Begin value and a value of Row in the last row is represented as an End value, then the Begin value of succeeding tablet data is larger than the End value of preceding tablet data under the tablet rule. A schematic diagram of a storage architecture thereof is as illustrated in FIG. 1.

The master server (Master) includes a metadata module in which the mapping relationship between values of the field of Row and tablet servers is stored. Each of the tablet servers include a data tablet module (HRegion) in which a mapping relationship between column fields (or families of columns, where several columns which are frequently accessed concurrently are defined as a family of columns, and one family of columns is stored in one column storage file) and corresponding column storage files (HStoreFile) is stored. One or more HStoreFiles are stored in a column module (HStore). Two files of Data and Index with a mapping relationship established between the two files are stored in each of the HStoreFiles. The file of Data stores data in the format of <Key, value>, and the file of Index stores an index of Key which may be used to locate directly a row of data in the file of Data.

Still taking the column field of UserID in Table 1 as an example, its corresponding files of Data and Index in a corresponding HStoreFile are as depicted in the following tables 4 and 5 respectively.

TABLE 4

| | Row | Value |
|---|---|---|
| 0 | 1 UserID | 13910001000 |
| 2 | 2 UserID | 13810001000 |
| 4 | 3 UserID | 13910001000 |
| 6 | 4 UserID | 13910001000 |

TABLE 5

| Row | Offset |
|---|---|
| 1 | 0 |
| 2 | 2 |
| 3 | 4 |
| 4 | 6 |

In the foregoing storage architecture in the prior art, an overall index mechanism for a distributed columnar database is formed like a tree, and the Row can be located rapidly according to three layers of structures, i.e., the metadata module, the data tablet modules, and the mapping between the files of Data and Index.

However since data is ranked and stored by the master keyword of Row instead of any non-master keyword of the column fields of Time, UserID, etc., in the prior art, an access with these non-master keywords has to be performed by traversing a whole data table according to the Row. The performance of traversing data without any index may be too low to be acceptable while mass data is queried even in the distributed database capable of handing a traversal request concurrently. A query with a non-master keyword is very common in a traditional database application. Therefore there is a need of an index mechanism for non-master keyword columns to accommodate a demand for usage thereof.

### SUMMARY OF THE INVENTION

Embodiments of the invention provide a method for creating an index of a distributed columnar database and method for querying a distributed columnar database and a device and system thereof to address the problem in an existing distributed columnar database that a rapid and efficient query can not be performed with any other column field than the field of Row.

An embodiment of the invention provides a method for creating an index of a distributed columnar database, which includes:

retrieving a column field from the distributed columnar database;

generating a column index file in which the column field is a keyword and which includes a mapping relationship between a value of the column field in the distributed columnar database and a corresponding value of the field of Row; and

storing the column index file into an index directory in the distributed columnar database corresponding to the column field.

An embodiment of the invention further provides a method for querying a distributed columnar database, which includes:

initiating by a client side a query request to a master server of the distributed columnar database;

returning, by the master server, information on a tablet server to the client side according to a locally stored mapping relationship between a value of the field of Row and a tablet server of the distributed columnar database;

initiating by the client side to the tablet server a query request carrying a column field of Query Result, a column field of Query Condition and field value information;

retrieving by the tablet server a matching column index file corresponding to the column field of Query Condition from a locally stored index directory of column fields, where the column index file includes a mapping relationship between a value of a column field in the distributed columnar database and a corresponding value of the field of Row; and

retrieving by the tablet server a corresponding value of the field of Row according to the matching column index file and the field value information, retrieving a result value satisfying the Query Condition according to a retrieved value of the field of Row and files of Index and Data corresponding to the column field of Query Result and returning the result value to the client side.

An embodiment of the invention further provides a device for creating an index of a distributed columnar database, which includes:

an retrieval unit configured to retrieve a column field from the distributed columnar database;

a generation unit configured to generate a column index file in which the column field retrieved by the retrieval unit is a keyword and which includes a mapping relationship between a value of the column field in the distributed columnar database and a corresponding value of the field of Row; and

a storage unit configured to store the column index file into an index directory in the distributed columnar database corresponding to the column field.

An embodiment of the invention further provides a distributed columnar database system including a master server and a tablet server, where the master server includes:

a first storage unit configured to store a mapping relationship between a value of the field of Row and a tablet server of a distributed columnar database; and

a query processing unit configured to receive a query request from a client side and to return information on the tablet server to the client side according to the mapping relationship stored in the first storage unit; and

the tablet server includes:

a column index file generation unit configured to retrieve a column field from the distributed columnar database, to generate a column index file in which the column field is a keyword and which includes a mapping relationship between a value of the column field in the distributed columnar database and a corresponding value of the field of Row, and to store the column index file into an index directory in the distributed columnar database corresponding to the column field;

a second storage unit configured to store a data file, an index file in which the field of Row is a keyword and a column index file, of a column field in tablet data allocated to the tablet server;

an analysis unit configured to receive a query request transmitted from the client side and to analyze a column field of Query Result, a column field of Query Condition and field value information carried in the query request;

a match unit configured to retrieve a corresponding matching column index file from the second storage unit according to the column field of Query Condition and to retrieve a corresponding value of the field of Row according to the matching column index file and the field value information;

a result query unit configured to retrieve a query result value satisfying the Query Condition by querying files of Index and Data corresponding to the column field of Query Result according to a retrieved value of the field of Row; and

a result returning unit configured to return the query result value to the client side initiating the query request.

An embodiment of the invention further provides a method for querying a distributed columnar database, which includes: initiating by a client side to a distributed columnar database a query request carrying a column field as a query condition and retrieving respective values of the column field and values of Row corresponding to the respective values; traversing all of the values of the column field and retrieving a value of Row corresponding to a specific value of the column field; retrieving a value of a target column field according to a retrieved value of Row corresponding to the specific value of the column field; and returning a retrieved value of the target column field to the client side.

In the embodiments of the invention, a column field other than the field of Row is retrieved from a distributed columnar database, a column index file in which the column field is a keyword and which includes a mapping relationship between values of the column field in the distributed columnar database and corresponding values of the field of Row is generated, and the generated column index file is stored into an index directory corresponding to the column field. Thus a client side can initiate to a master server of the distributed columnar database a query request carrying a column field of Query Result, a column field of Query Condition and field value information, and the master server and tablet servers can retrieve a matching column index file corresponding to the column field of Query Condition from a stored index directory of column fields, retrieve a corresponding value of the field of Row from the column index file, retrieve a result value satisfying the Query Condition from a data file corresponding to the column field of the Query Result according to the retrieved value of the field of Row and return the result value to the client side. In this way, the client side can perform a rapid and efficient query with an index using a column field other than the field of Row in the distributed columnar database.

### BRIEF DESCRIPTION OF THE DRAWINGS

FIG. 1 illustrates a schematic diagram of a storage architecture of a distributed columnar database in the prior art;

FIG. 2 illustrates a flow chart of a method for creating an index of a distributed columnar database according to an embodiment of the invention;

FIG. 3 illustrates a schematic diagram of a file structure in an HStoreFile according to an embodiment of the invention;

FIG. 4 illustrates a flow chart of a method for querying a distributed columnar database according to an embodiment of the invention;

FIG. 5 illustrates a schematic diagram of a structure of a device for creating an index of a distributed columnar database according to an embodiment of the invention;

FIG. 6 illustrates a schematic diagram of an internal structure of a generation unit in the device for creating an index of a distributed columnar database according to the embodiment of the invention; and

FIG. 7 illustrates a schematic diagram of a structure of a distributed columnar database system.

### DETAILED DESCRIPTION OF THE EMBODIMENTS

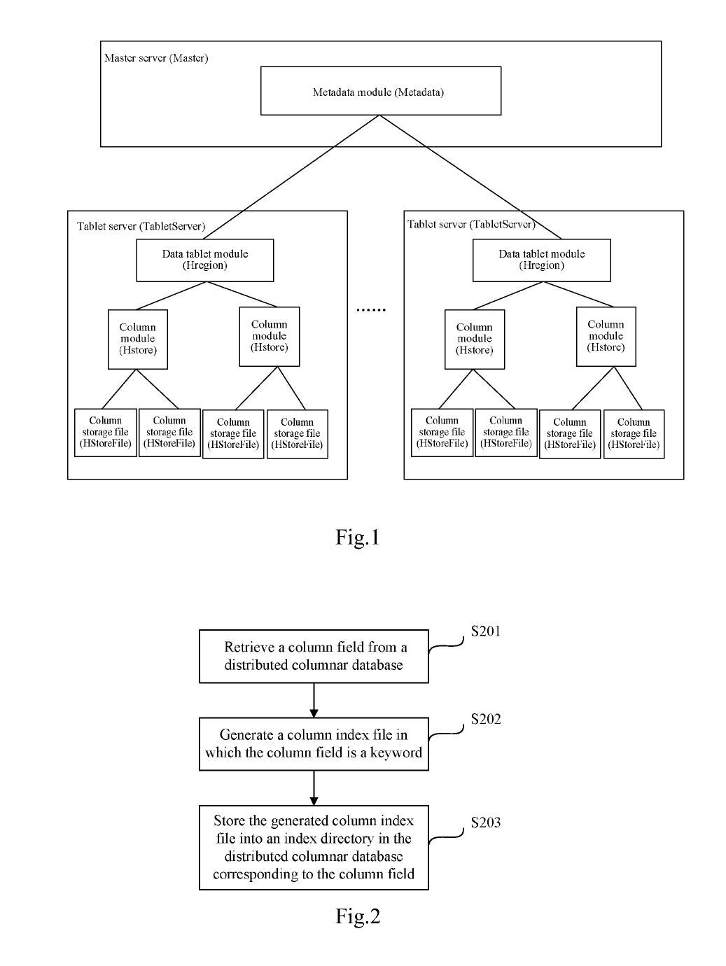

An embodiment of the invention provides a method for creating an index of a distributed columnar database performed in a flow as illustrated in FIG. 2, which includes the following operations S201-S203.

In the operation S201, a column field is retrieved from the distributed columnar database.

In the operation S202, a column index file in which the retrieved column field is a keyword and which includes a mapping relationship between values of the column field in the distributed columnar database and corresponding values of the field of Row is generated.

In the operation S202, a corresponding column index file can be generated respectively for each retrieved column field (or family of columns).

In a practical application, in order to facilitate query by a user, a corresponding column index file can theoretically be generated for each of the column fields other than the field of Row in the distributed columnar database. Of course, if a column field is substantially not worth a query and practically is hardly used for a query, then it is not necessary to generate a corresponding column index file for the column field, thus conserving a storage resource occupied for the database.

In the operation S203, the generated column index file is stored into an index directory in the distributed columnar database corresponding to the column field.

As can be apparent from the foregoing description of the flow, the invention generates corresponding column index files respectively for column fields other than the field of Row in a distributed columnar database and stores the corresponding column index files into index directories corresponding to the column fields.

Still taking Table 1 above as an example, a column index file generated for the column field of UserID is as depicted in the following Table 6:

TABLE 6

| UserID | Row |
|---|---|
| 13910001000 | 1 |
| | 3 |
| | 4 |
| 13810001000 | 2 |

In Table 6, the left column represents values of the field of UserID in the original distributed columnar database, and as apparent from Table 3, there are only two values of the field, i.e. 13910001000 and 13810001000; and the right column represents values of the field of Row, i.e., values of the field of Row respectively corresponding to the values of the field of UserID, and as can be apparent from Table 3, values of the field of Row corresponding to 13910001000 are 1, 3 and 4 respectively and a value of the field of Row corresponding to 13810001000 is 2.

A detailed description will be presented below in connection with a storage architecture of a distributed columnar database.

A first level index directory stored in a master sever of a distributed columnar database includes a mapping relationship between values of the field of Row and tablet servers. For example, the first level index directory is stored in a metadata module of the master server. The master server can locate all of the tablet servers according to the first level index directory.

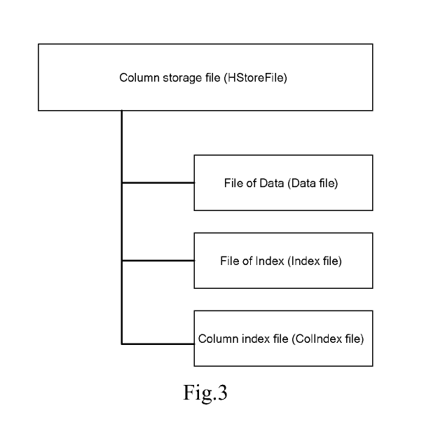

Second and third index directories are stored in each of the tablet servers, and the second index directory includes a mapping relationship between column fields and column storage files. For example, the second index directory is stored in data tablet modules of the tablet servers. Data files, index files, and column index files generated according to the invention, of the column fields corresponding to the column storage files are stored in the third index directory. The third index directory is equivalent to the HStoreFile in the prior art except that a column index file corresponding to a column field is added in the HStoreFile in a hierarchy as schematically illustrated in FIG. 3.

Three files are stored in a column storage file (HStoreFile), which include:

a file of Data (referred hereinafter as a Data file for convenience of the description), a file of Index (referred hereinafter as a Index file for convenience of the description) in which the field of Row is a keyword and a corresponding column index file (ColIndex) (referred hereinafter as a ColIndex file for convenience of the description), corresponding to the column field in tablet data allocated for a corresponding tablet server.

A column index file corresponding to a column field may be created in a tablet server as specified by a user. That is, the user is provided in the tablet server with an interface via which an index is created and deleted so that the user may create column index files corresponding to all or a part of column fields as desired by himself or herself.

In the forgoing method according to the embodiment of the invention, the second and third index directories are created in a tablet server respectively for a set or each of sets of tablet data stored in the tablet server.

After data is added, deleted or modified in the distributed columnar database, it is necessary to regenerate a column index file or modify corresponding data in a generated column index file so as to ensure consistency of the data in the column index file with relevant data in the current database, thereby obviating an improper query result of a subsequent query.

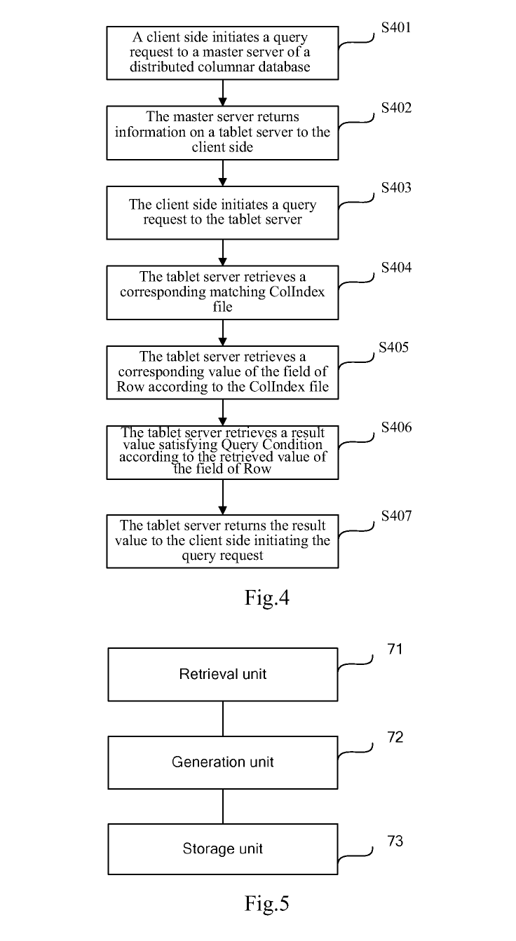

Based upon the same inventive idea, the invention further provides a method for querying a distributed columnar database performed particularly in a flow as illustrated in FIG. 4, which includes the following operations S401-S407.

In the operation S401, a client side initiates a query request to a master server of a distributed columnar database;

In the operation S402, the master server returns information on a tablet server to the client side according to a locally stored mapping relationship between values of the field of Row and tablet servers;

In the operation S403, the client side initiates to the tablet server a query request carrying a column field of Query Result, a column field of Query Condition and field value information;

In the operation S404, the tablet server retrieves a matching ColIndex file corresponding to the column field of Query Condition from a locally stored index directory of column fields;

In the operation S405, the tablet server retrieves a corresponding value of the field of Row according to the matching ColIndex file and the field value information of the column field of Query Condition;

In the operation S406, the tablet server retrieves a result value satisfying the Query Condition according to the retrieved value of the field of Row and Index and Data files corresponding to the column field of Query Result; and

In the operation S407, the tablet server returns the result value satisfying the Query Condition to the client side initiating the query request.

Still taking Table 1 above as an example, the query request is assumed as “Select SignalType from GNTABLE where UserID=‘13910001000’”, that is, a signal type used correspondingly for a user with the column field of UserID as “13910001000” is to be selected from the data table of GNTABLE. This query request carries the column field of Query Condition which is the field of “UserID” with the field value of “13910001000” and the column field of Query Result which is the field of “SignalType”.

In the foregoing flow according to the invention, the client side firstly initiates a query request to the master server; the master server returns information on (a) tablet server(s) to the client side; and then the client side further initiates a query request to the tablet server or a query request concurrently to respective tablet servers to perform a distributed query; each of the tablet servers retrieves a result value satisfying Query Condition from locally stored tablet data and then returns it to the client side; and the client receives the query result value returned from the respective tablet servers, that is, retrieves final query data.

Specifically, upon reception of the query request, the tablet server retrieves a matching column index file (as depicted in Table 6) corresponding to the column field of Query Condition, i.e., the field of “UserID”, from a locally stored index directory of column fields, retrieves corresponding values “1, 3, 4” of the field of Row with the value “13910001000” of the field of UserID from the matching column index file and then retrieves a query result as done to query a distributed columnar database in the prior art after retrieving the values of the field of Row, that is, retrieves a corresponding value of the field of SignalType satisfying a query requirement according to Index and Data files of a column field (i.e., the field of “SignalType”) corresponding to the current Query Result.

When the query request carries plural query conditions, the tablet server retrieves values of the field of Row corresponding to the respective query conditions, determines a final value of the field of Row satisfying all of the query conditions according to a logic relationship between the query conditions (logical OR, Logical AND or combination thereof) and then retrieves a result value satisfying the query conditions according to the determined final value of the field of Row and returns the result value to the client side.

With the method for querying a distributed columnar database according to the invention, a client side can initiate a query request concurrently to respective tablet servers so that a data query with plural conditions can be processed concurrently at the respective tablet servers to thereby perform a rapid and efficient query. Without a distributed query, a query with plural conditions has to be processed centrally at a master server, and such a situation may occur with a query of mass data that the mass data can not be processed at a single node.

Secondly, with the method for querying a distributed columnar database according to the invention, a tablet server directly processes a data query locally, that is, the tablet server only needs to process data stored locally for retrieving a query result without interaction with a network, thus reducing an overhead over the network and further improving the rate and efficiency of a query.

Based upon the same inventive idea, the invention further provides a device for creating an index of a distributed columnar database with a schematic diagram of a structure thereof as illustrated in FIG. 5, which includes:

an retrieval unit 71 configured to retrieve a column field from a distributed columnar database;

a generation unit 72 configured to generate a column index file in which the column field retrieved by the retrieval unit 71 is a keyword and which includes a mapping relationship between values of the column field in the distributed columnar database and corresponding values of the field of Row; and

a storage unit 73 configured to store the column index file generated by the generation unit 72 into an index directory in the distributed columnar database corresponding to the column field.

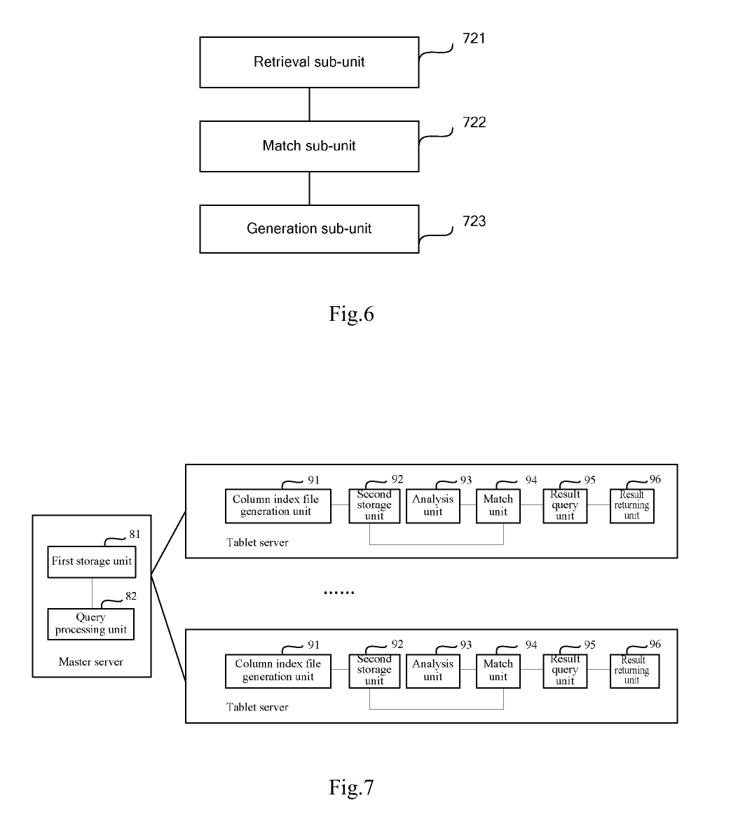

Particularly, the generation unit 72 has an internal structure as illustrated in FIG. 6 and may include:

an retrieval sub-unit 721 configured to retrieve a value of the column field in the distributed columnar database;

a match sub-unit 722 configured to retrieve a matching value of the field of Row corresponding to the value of the column field from the distributed columnar database; and

a generation sub-unit 723 configured to create the mapping relationship between values of the column field and corresponding values of the field of Row and to generate the column index file.

In a practical application, the device for creating an index of a distributed columnar database according to the invention may be a software module embedded into a tablet server in which tablet data of a distributed columnar database is stored.

Based upon the same inventive idea, the invention further provides a distributed columnar database system with a schematic diagram of a structure thereof as illustrated in FIG. 7, which includes a master server and a tablet server, where:

the master server includes:

a first storage unit 81 configured to store a mapping relationship between values of the field of Row and the tablet servers of a distributed columnar database; and

a query processing unit 82 configured to receive a query request from a client side and to return information on a tablet server to the client side according to the mapping relationship stored in the first storage unit 81;

the tablet server includes:

A column index file generation unit 91 configured to retrieve a column field from the distributed columnar database, to generate a column index file in which the column field is a keyword and which includes a mapping relationship between values of the column field in the distributed columnar database and corresponding values of the field of Row, and to store the generated column index file into an index directory in the distributed columnar database corresponding to the column field;

a second storage unit 92 configured to store a data file, an index file in which the field of Row is a keyword and a column index file of a column field, corresponding to the column field in allocated tablet data;

an analysis unit 93 configured to receive a query request transmitted from the client side and to analyze a column field of Query Result, a column field of Query Condition and field value information carried in the query request;

a match unit 94 configured to retrieve a corresponding matching column index file from the second storage unit 92 according to the column field of Query Condition carried in the query request and to retrieve a corresponding value of the field of Row corresponding to a field value of the column field of Query Condition according to the matching column index file and the field value information;

a result query unit 95 configured to retrieve a query result value satisfying the Query Condition by querying index and data files corresponding to the column field of Query Result according to the retrieved value of the field of Row; and

a result returning unit 96 configured to return the query result value to the client side initiating the query request.

The master server is configured to store the mapping relationship between values of the field of Row and tablet servers of the distributed columnar database; and the tablet server is configured to store the ColIndex file of a column field in addition to the Data file and Index file in which the field of Row is a keyword, corresponding to the column field in the allocated tablet data; the ColIndex file is stored together with the Data and Index files into an index directory corresponding to the column filed. The column index file created in the method according to the foregoing embodiment of the invention includes the mapping relationship between values of the column field in the distributed columnar database and corresponding values of the field of Row.

As described previously, the first level index directory which may be stored in the master server includes the mapping relationship between values of the field of Row and tablet servers; and the second and third index directories may be stored in the tablet server, where the second index directory includes a mapping relationship between column fields and column index files, and the Data file, the Index file, and the ColIndex file created according to the invention, of the column field corresponding to the column storage file are stored in the third index directory.

In the distributed columnar database system according to the invention, there may be one or more tablet servers.

In summary, the invention retrieves a column filed other than the field of Row in a distributed columnar database, generates a column index file in which the column field is a keyword and which include a mapping relationship between values of the column field in the distributed columnar database and corresponding values of the field of Row, and stores the generated column index file into an index directory corresponding to the column field, so that a client side can initiate to a master server of the distributed columnar database a query request carrying a column field of Query Result, a column field of Query Condition and field value information, a corresponding value of the field of Row can be retrieved by retrieving a matching column index file corresponding to the column field of Query Condition, and then a query result can be retrieved according to the value of the field of Row as done for a query in the prior art, thereby querying the distributed columnar database with the column filed other than the field of Row and accommodating significantly a usage demand of a user.

With the method for querying a distributed columnar database according to the invention, a client side initiates a query request concurrently to respective tablet servers so that a data query with plural conditions is processed concurrently at the respective tablet servers to thereby perform a rapid and efficient query. Without the method for querying a distributed columnar database according to the invention, such an index method commonly used in an existing database is adopted that an index table, storing a mapping from column data in column fields to locations where the column data is stored, is created in a master server where a query with plural conditions is processed centrally and in this conventional index method, a memory overflow resulting in a processing failure is very likely to occur in the master server while all of condition data is being processed, and index locating has to be performed three times to locate the stored data, which may increase an overhead over a network.

Secondly, with the method for querying a distributed columnar database according to the invention, a tablet server directly processes a data query locally, that is, the tablet server only needs to process data stored locally for retrieving a query result without interaction with a network, thus reducing an overhead over the network and further improving the rate and efficiency of a query.

Thirdly, with the method for querying a distributed columnar database according to the invention, each query is performed for a column index file with temporal complexity of merely log₂N as opposed to that of N required for a traversal query.

Those skilled in the art can appreciate that the invention may be modified variously to also attain the object of the invention. For example in a method for creating an index of a distributed columnar database according to an embodiment of the invention, a column index file in which a column index other than the column of Row is a keyword may not be generated, but simply according to an index file in which the field of Row is Keyword, a value of Row corresponding to a specific value of a condition column field may be retrieved by traversing values of the condition column field, and further a value of a target column field may be retrieved according to the value of Row. Therefore, the invention further provides a method for querying a distributed columnar database, which includes: initiating by a client side to a distributed columnar database a query request carrying a column field as a Query Condition; retrieving respective values of the column field and values of Row corresponding to the respective values; traversing all of the values of the column field and retrieving a value of Row corresponding to a specific value of the column field; retrieving a value of a target column field according to the retrieved value of Row corresponding to the specific value of the column field; and returning retrieved value of the target column field to the client side. In this solution, creation of a new index is not required, but an application system at an upper layer shall be capable of receiving all of the values of the condition column field.

Those ordinarily skilled in the art can appreciate that all or a part of the operations in the methods according to the embodiments may be performed with program instructing relevant hardware, which can be stored in a computer readable storage medium, e.g., an ROM/RAM, a magnetic disk, an optical disk, etc.

Evidently those skilled in the art can make various modifications and variations to the invention without departing from the scope of the invention. Thus the invention is also intended to encompass these modifications and variations thereto provided the modifications and variations come into the scope of the claims appended to the invention and their equivalents.

1. A method for creating an index of a distributed columnar database, comprising:
retrieving a column field from the distributed columnar database;
generating a column index file in which the column field is a keyword and which comprises a mapping relationship between a value of the column field in the distributed columnar database and a corresponding value of the field of Row; and
storing the column index file into an index directory in the distributed columnar database corresponding to the column field.

2. The method of claim 1, further comprising:
storing a mapping relationship between a value of the field of Row and a tablet server of the distributed columnar database, in a master server of the distributed columnar database; and
storing in the tablet server a data file, an index file in which the field of Row is a keyword and a generated column index file, corresponding to a column field in tablet data allocated to the tablet server.

3. The method of claim 2, wherein the distributed columnar database is in a structure of three-level index directories comprising:
a first level index directory stored in the master server and comprising the mapping relationship between the value of the field of Row and the tablet server; and
second and third level index directories stored in the tablet server, wherein the second level index directory comprises a mapping relationship between a column field and a column storage file and the third level index directory comprises a data file, an index file and a column index file of the column field corresponding to the column storage file.

4. The method of claim 3, wherein when one tablet server stores one or more than one set of tablet data, the second and third index directories are created for each set of tablet data.

5. The method of claim 1, wherein after data is added, deleted or modified in the distributed columnar database, the column index file is regenerated or corresponding data in the column index file is modified.

6. A method for querying a distributed columnar database, comprising:
initiating by a client side a query request to a master server of the distributed columnar database;
returning, by the master server, information on a tablet server to the client side according to a locally stored mapping relationship between a value of the field of Row and a tablet server of the distributed columnar database;
initiating by the client side to the tablet server a query request carrying a column field of Query Result, a column field of Query Condition and field value information;
retrieving by the tablet server a matching column index file corresponding to the column field of Query Condition from a locally stored index directory of column fields, wherein, the column index file comprises a mapping relationship between a value of a column field in the distributed columnar database and a corresponding value of the field of Row; and
retrieving by the tablet server a corresponding value of the field of Row according to the matching column index file and the field value information, retrieving a result value satisfying the Query Condition according to a retrieved value of the field of Row and index and data files corresponding to the column field of Query Result and returning the result value to the client side.

7. The method of claim 6, wherein when tablet server information returned from the master server relates to plural tablet servers, the client side initiates the query request concurrently to the respective tablet servers.

8. The method of claim 6, wherein when the query request transmitted to the tablet server carries more than one query condition, the tablet server retrieves values of the field of Row corresponding to the respective query conditions, determines a final value of the field of Row satisfying all of the query conditions according to a logic relationship between the query conditions and then retrieves a result value satisfying the query conditions from the data file corresponding to the column field of Query Result according to the final value of the field of Row and returns the result value to the client side.

9. A device for creating an index of a distributed columnar database, comprising:
an retrieval unit configured to retrieve a column field from the distributed columnar database;
a generation unit configured to generate a column index file in which the column field retrieved by the retrieval unit is a keyword and which comprises a mapping relationship between a value of the column field in the distributed columnar database and a corresponding value of the field of Row; and
a storage unit configured to store the column index file into an index directory in the distributed columnar database corresponding to the column field.

10. The device of claim 9, wherein the generation unit comprises:
an retrieval sub-unit configured to retrieve a value of the column field in the distributed columnar database;
a match sub-unit configured to retrieve a matching value of the field of Row corresponding to the value of the column field from the distributed columnar database; and
a generation sub-unit configured to create the mapping relationship between the value of the column field and the corresponding value of the field of Row and to generate the column index file.

11. The device of claim 9, wherein the device is a software module embedded into a tablet server in which tablet data of the distributed columnar database is stored.

12. A distributed columnar database system, comprising a master server and a tablet server, wherein:
the master server comprises:
a first storage unit configured to store a mapping relationship between a value of the field of Row and a tablet server of a distributed columnar database; and
a query processing unit configured to receive a query request from a client side and to return information on the tablet server to the client side according to the mapping relationship stored in the first storage unit; and
the tablet server comprises:
a column index file generation unit configured to retrieve a column field from the distributed columnar database, to generate a column index file in which the column field is a keyword and which comprises a mapping relationship between a value of the column field in the distributed columnar database and a corresponding value of the field of Row, and to store the column index file into an index directory in the distributed columnar database corresponding to the column field;
a second storage unit configured to store a data file, an index file in which the field of Row is a keyword and a column index file, of a column field in tablet data allocated to the tablet server;
an analysis unit configured to receive a query request transmitted from the client side and to analyze a column field of Query Result, a column field of Query Condition and field value information carried in the query request;
a match unit configured to retrieve a corresponding matching column index file from the second storage unit according to the column field of Query Condition and to retrieve a corresponding value of the field of Row according to the matching column index file and the field value information;
a result query unit configured to retrieve a query result value satisfying the Query Condition by querying index and data files corresponding to the column field of Query Result according to a retrieved value of the field of Row; and
a result returning unit configured to return the query result value to the client side initiating the query request.

13. The system of claim 12, wherein a first level index directory comprising the mapping relationship between a value of the field of Row and a tablet server of the distributed columnar database is stored in the first storage unit of the master server; and
second and third index directories are stored in the second storage unit of the tablet server, wherein the second index directory comprises a mapping relationship between a column field and a column storage file and the third index directory comprises the data file, the index file and the column index file of the column field corresponding to the column storage file.

14. The system of claim 12, wherein there are plural tablet servers.

15. A method for querying a distributed columnar database, comprising:
initiating by a client side to a distributed columnar database a query request carrying a column field as a query condition and retrieving respective values of the column field and values of the filed of Row corresponding to the respective values;
traversing all of the values of the column field and retrieving a value of the filed of Row corresponding to a specific value of the column field; and
retrieving a value of a target column field according to a retrieved value of the field of Row corresponding to the specific value of the column field and returning the value of the target column field to the client side.

16. The method of claim 7, wherein when the query request transmitted to the tablet server carries more than one query condition, the tablet server retrieves values of the field of Row corresponding to the respective query conditions, determines a final value of the field of Row satisfying all of the query conditions according to a logic relationship between the query conditions and then retrieves a result value satisfying the query conditions from the data file corresponding to the column field of Query Result according to the final value of the field of Row and returns the result value to the client side.

17. The device of claim 10, wherein the device is a software module embedded into a tablet server in which tablet data of the distributed columnar database is stored.

18. The system of claim 13, wherein there are plural tablet servers.
